(19) United States
(12) Patent Application Publication
(10) Pub. No.: US 2025/0385824 A1
(43) Pub. Date: Dec. 18, 2025

(54) LOW-COMPLEX, RELIABLE MULTIDIMENSIONAL ORTHOGONAL TIME-FREQUENCY SPACE (ND-OTFS) MODULATION-BASED COMMUNICATION SYSTEM.

(71) Applicant: INDIAN INSTITUTE OF TECHNOLOGY KHARAGPUR, Kharagpur (IN)

(72) Inventors: Ch Santosh Reddy, Kharagpur (IN); Debarati Sen, Kharagpur (IN)

(73) Assignee: INDIAN INSTITUTE OF TECHNOLOGY KHARAGPUR, Kharagpur (IN)

(21) Appl. No.: 19/022,529

(22) Filed: Jan. 15, 2025

(30) Foreign Application Priority Data
Jun. 14, 2024 (IN) 202431046217

(51) Int. Cl. H04L 27/26; H04L 5/00

(52) U.S. Cl. CPC H04L 27/2639; H04L 5/0023

(57) ABSTRACT

The present invention discloses a low-complex, reliable multidimensional orthogonal time-frequency space (ND-OTFS) modulation-based communication system for uplink and downlink wireless communication between resource-constrained Internet of Things (IoT) and machine-to-machine (M2M) devices comprising at least one transmitter configured to transmit bit stream involving N-Dimensional signal mapper and OTFS frame and at least one receiver configured to be integrated into said IoT or M2M devices, featuring a low-complexity detector for receiving the transmitted bit stream.

### RELATED APPLICATIONS

This application claims priority to India patent application No. 202431046217, Filing Date Jun. 14, 2024, entitled LOW-COMPLEX, RELIABLE MULTIDIMENSIONAL ORTHOGONAL TIME-FREQUENCY SPACE (ND-OTFS) MODULATION-BASED COMMUNICATION SYSTEM; which is incorporated herein by reference in its entirety.

### FIELD OF THE INVENTION

The present invention relates to Internet of Things (IoT) and machine-to-machine (M2M) communication. More specifically, the present invention is directed to a low-complex, reliable N-Dimensional orthogonal time-frequency space (ND-OTFS) modulation-based communication system and method is provided. The system and method are developed for uplink and downlink wireless communication for resource-constrained IoT and M2M devices. The transmitter module of the system is configured to transmit a bit stream involving an adaptive OTFS frame with a N-D constellation to the in-phase/quadrature-phase (I/Q) symbol mapper for improving reliability. The receiver is configured with a low-complex detector with an I/Q symbol to N-D constellation de-mapper for receiving the transmitted bit stream. Moreover, a N-D constellation generation mechanism for the Q-th order quadrature amplitude modulation (QAM) symbol is proposed.

### BACKGROUND OF THE INVENTION

A 5G network's use case in the Internet of Things (IoT) and machine-to-machine (M2M) communication is a breakthrough that offers connected vehicle networks with the proper blend of speed, latency, and cost. The IoT or M2M devices deployed for mobility-associated applications necessitate an advanced wireless communication system to ensure safe and efficient operation. Compared to conventional waveforms like orthogonal frequency division multiplexing (OFDM), the orthogonal time frequency space (OTFS) is superior due to its delay-Doppler domain modulation in high-mobility circumstances. The bit error rate (BER) can be significantly improved at higher modulation orders by incorporating the N-dimensional (N-D) mapper into the standard OTFS modulation method. The key reported works in this field are as follows

In C. S. Reddy, D. Sen, and C. Singhal, “Performance analysis of NR based vehicular IoT system with OTFS modulation,” in 2021 IEEE 94th Vehicular Technology Conference (VTC2021-Fall). IEEE, 2021, pp. 1-6, NR-based vehicular IoT system with OTFS modulation is proposed. It uses the constellation mapper as defined by 3GPP standards. Limited to design for the 2-dimensional BPSK and QPSK constellations.

In Y. Chen, L. Zhao, Y. Jiang, W. Li, H. Gao, and C. Liu, “OTFS waveform based on 3-D signal constellation for time-variant channels,” IEEE Communications Letters, 2023, 3D Constellation for Q-QAM is proposed. Different 3D shapes are used to define the constellation, and those are as follows: a regular tetrahedron for the 4-order signal constellation, two cubes with unequal sides for the 16-order, a four-layer structure each with four rows and four columns having equal distance from two adjacent points for 64-order, and a layered cross-shaped for the 128-order. The designed OTFS frame is padded with zeros to make it square shaped frame which is becoming overhead at the receiver. The designed system does not take care of the 3GPP standards.

In S. G. Kang, Z. Chen, J. Y. Kim, J. S. Bae, and J. Lim, “Construction of higher-level 3-D signal constellations and their accurate symbol error probabilities in AWGN,” IEEE Trans. Signal Process., vol. 59, no. 12, pp. 6267-6272 December 2011, a 3-D perfect-lattice constellation for the 64-QAM and 512-QAM is designed. A 3-D cross-lattice constellation for 32-QAM, 128-QAM, and 256-QAM is designed. The decision region for all 3-D QAM constellations is defined, and its effect in an AWGN channel has been studied.

US2020/0412595 A1 discloses Transpositional modulation to increase the constellation dimension. The method increases the constellation point to be with four coordinates. The first two coordinates drive the QAM modulation, and the later two coordinates drive the transpositional modulation to achieve higher spectral efficiency.

It is thus there has been a need for developing improved low complex system and method for uplink and downlink wireless communication for resource-constrained IoT and M2M devices involving an adaptive OTFS frame with an optimized N-D constellation to improve the BER.

### Object of the Invention

It is thus the basic object of the present invention is to provide a low-complex, reliable ND-OTFS modulation-based communication system and method for uplink and downlink wireless communication between resource-constrained IoT and M2M devices.

Another object of the present invention is to develop a low-complex, reliable ND-OTFS modulation-based communication system and method with optimized N-D constellation for significantly improving BER performance of the system.

Yet another object of the present invention is to develop a method to map the N-D constellation points to the in-phase/quadrature-phase (I/Q) symbol for OTFS modulation for improving reliability.

Another object of the present invention is to develop a low-complex, reliable ND-OTFS modulation-based communication system and method with optimized N-D constellation and minimum Euclidean distance of the N-D signal constellations which can outperforms the conventional OTFS system in terms of BER performance.

### SUMMARY OF THE INVENTION

Thus, according to the basic aspect of the present invention there is provided a low-complex, reliable multidimensional orthogonal time-frequency space (ND-OTFS) modulation-based communication system for uplink and downlink wireless communication between resource-constrained Internet of Things (IoT) and machine-to-machine (M2M) devices comprising
at least one transmitter configured to transmit bit stream involving N-Dimensional signal mapper and OTFS frame; and
at least one receiver configured to be integrated into said IoT or M2M devices, featuring a low-complexity detector for receiving the transmitted bit stream.

In the present system, the downlink (DL) or uplink (UL) wireless communication transmitter for a multi-dimensional transceiver apparatus of the ND-OTFS-based IoT and M2M devices includes
a DL-SCH (Downlink Sharing Channel) or UL-SCH (Uplink Sharing Channel) 100;
a PDSCH (Physical Downlink Sharing Channel) or PUSCH (Physical Uplink Sharing Channel) 110, and
an OTFS modulator 120 that maps DD (Delay Dopler) domain information symbol to time domain samples.

In the present system, said OTFS modulator 120 is configured to treat the input symbols as in the DD domain and based on total number of delay samples and Doppler samples (V), information symbols are arranged in a matrix of size (U×V);
said OTFS modulator 120 includes
an Inverse symplectic Fast Fourier transform (ISFFT) 121 unit to obtain the time-frequency samples of the information symbols;
an OFDM modulator 122 unit to obtain the time domain samples, whereby the time-modulated signal passes through a time-varying channel 130.

In the present system, the downlink wireless communication receiver for a multi-dimensional transceiver apparatus of the ND-OTFS-based IoT systems includes
a matching filter 140 to detect the presence of transmitted template in the unknown signal;
an OTFS demodulator 150 including
   an OFDM demodulator 151 to retrieve the time-frequency domain samples, and
   a symplectic Fast Fourier transform (SFFT) unit 152 to get back to the DD domain;
an equalizer 160 to equalizes the information symbols in the DD domain; and
a PDSCH or PUSCH decoder 170 and a DL-SCH or UL-SCH decoder 180 to get back the information bits.

In the present system, the PDSCH block 110 comprises
a scrambling unit 200 that scrambles the input bits using gold sequences as defined in TR-38.211;
a N-D signal mapper 210 that maps the information symbols to N-D space using N-D constellations;
an I/Q converter 220 that transforms the N-D signal mapped matrix into a complex vector;
a layer mapping 230 that distribute the symbols into multiple layers depending upon the device settings;
an antenna port mapping 240 that maps each layer to respective antenna ports, mapping to a virtual resource block (VRB) 250 that creates virtual resource grid by arranging the symbols in delay-first, Doppler second method; and
a VRB to physical resource block (PRB) mapper 260 that maps each VRB to PRB with interleaved mapping or non-interleaved method, whereby selection of the number of layers and mapping VRB to PRB differs from vendor to vendor, and the same information is passed to the device through the control plane.

In the present system, the PUSCH block 110 comprises
a scrambling unit 300 that scrambles the input bits to ensure the uniform power distribution across different frequency and time resources;
a N-D signal mapper 310 that maps the information symbols to N-D space using N-D constellations;
an I/Q converter 320 that transforms the N-D signal mapped matrix into a complex vector;
a layer mapping 330 that distribute the symbols into multiple layers depending upon the device settings;
a transform precoding 340 that converts the data into the forms of DFT-s-OFDM format depending upon the number of layers and the number of antenna ports;
a precoding block 350 multiplies a precoding matrix to the data, mapping to a VRB 360 creates a virtual resource grid by arranging the symbols in delay-first, Doppler second method; and
a VRB to a PRB mapper 370 that maps each VRB to PRB with interleaved mapping or non-interleaved method, wherein the selection of the number of layers and mapping VRB to PRB differs from vendor to vendor, and the same information is passed to the device through the control plane.

In the present system, the IoT or M2M devices are configured to send a request to register themselves in control channel network at a given time instant when the devices are required to transmit or receive any information, including exchanging the status of the devices with the base station and information about the mobility condition including current speed through Random-Access Channel, whereby a change in speed during the communication is shared through an uplink control channel.

In the present system, a payload size of A which is intended to be transmitted to the IoT device or the payload is to be requested by the IoT device during an active mode of operation, said payload A go through the DL-SCH in the downlink and UL-SCH in the uplink, as applicable where b_{CRC} bits are attached and processed further in the DL-SCH/UL-SCH block 100 and passed to the modified PDSCH/PUSCH block 110 and the information bits get scrambled here with gold sequences at 200 or 300, whereby these scrambled bits dₛ=(b₀, b₁, . . . , bₚ) passed through the N-D signal mapper 210 or 310 for downlink and uplink, respectively, where the size of the scrambled bit is given as p=2UV log₂ Q/N.

In the present system, the N-D signal mapper 210 or 310 find the Q-order N-D signal constellation involving
finding the Q points in a N-dimensional space to maximize the minimum pairwise Euclidean distance;
mapping the Q points to the Q-order signal constellation;
wherein each point p_{q} is represented by a N-dimensional vector of coordinates: p_{q}=(α_{q1}, α_{q2}, . . . , α_{qN}), where q=1, 2, . . . , Q, where the Euclidean distance between points pₘ and pₙ is given as

$$d ( {p}_{m} , {p}_{n} ) = \sqrt{{( {α}_{m 1} - {α}_{n 1} )}^{2} + {( {α}_{m 2} - {α}_{n 2} )}^{2} + … + {( {α}_{mN} - {α}_{nN} )}^{2}} \qquad ( 1 )$$

and to maximize the minimum Euclidean distance between the Q points, optimization problem is formulated as

$${max}_{p ∈ ℤ} min ( d ( {p}_{m} , {p}_{n} ) ) \qquad ( 2 a )$$

$$s . t . - 1 \leq {α}_{q t} \leq 1 ∀ q ∈ Q , t ∈ N , \qquad ( 2 b )$$

$$d ( {p}_{m} , {p}_{n} ) \geq c ∀ m \neq n , \qquad ( 2 c )$$

$${\sum }_{n = 1}^{N} {α}_{q t} \neq 0 ∀ q ∈ Q \qquad ( 2 d )$$

here, the constraint (2b) restricts the values of the variables to be between −1 and 1 for all q∈Q, and t∈M or N and the minimum required Euclidean distance between two distinct points, pₘ and pₙ is assigned a lower boundary to ensure non-zero entry (2c), where the constraints (2d) ensure that the optimized points have no origin;
involving a heuristic method to solve the optimization problems, where Q_{N-D}∈R^{Q×N} is the optimized points which are mapped to Q-order signal constellation and are represented as

$${Q}_{N - D} = [ \begin{matrix}{β}_{11} & {β}_{21} & ⋯ & {β}_{Q 1} \\ {β}_{12} & {β}_{22} & & {β}_{Q 2} \\ ⋮ & & ⋱ & ⋮ \\ {β}_{1 N} & {β}_{2 N} & ⋯ & {β}_{QN}\end{matrix} ] . \qquad ( 3 )$$

In the present system, the N-D signal mapper 210 or 310 arrange the bits in N-parallel lines, and then each column is mapped to a symbol from the Q symbol, which is given as

$${X}_{N - D} = [ \begin{matrix}{β}_{11} & {β}_{21} & ⋯ & {β}_{p 1} \\ {β}_{12} & {β}_{22} & & {β}_{p 2} \\ ⋮ & & ⋱ & ⋮ \\ {β}_{1 N} & {β}_{2 N} & ⋯ & {β}_{pN}\end{matrix} ] . \qquad ( 4 )$$

In the present system, the I/Q converter 220 or 320 generates the I/Q samples from the X_{N-D} that is transmitted in a digital communication system, where the expression for the I/Q converter is given as

$${x}_{I / Q} ( i ) = {X}_{N - D} ( 2 i ) + {jx}_{N - D} ( 2 i + 1 ) , \\ where {X}_{N - D} = vec ( {X}_{N - D} ) ; \qquad ( 5 )$$

whereby the I/Q samples are processed through layer mapping 230 or 330, wherein in the downlink communication, the data is then passed through the antenna mapping 240 and in the uplink communication system, the layer data passes through the transform precoding 340 and precoding 350, subsequently, the data symbols are mapped to the VRB 250 or 360 and mapped from VRB to PRB 260 or 370 for downlink and uplink, respectively and finally at the end of the modified PDSCH/PUSCH block 110, the information symbols x̅_{I/Q} treated as in the Delay-Doppler domain are obtained.

In the present system, the information symbols are arranged in an adaptive OTFS frame S∈C^{U×V}, whereby the transmitted time-domain signal for OTFS modulation 120 in vector form can be written as

$$s = ( {F}_{V}^{H} ⊗ {I}_{U} ) {\overline{x}}_{I / Q} , \qquad ( 6 )$$

assuming channel 130 has a memory length of L, so CP of length (L−1) is added to S before transmission and the received signal after discarding the CP can be written as

$$r = Hs + {w}^{'} , \qquad ( 7 )$$

where \acute{w} is the AWGN in the time domain and H is the UV×UV channel matrix with P multipath defined as

$$H = {\sum }_{i = 1}^{P} {h}_{i} {\prod }^{{l}_{i}} {Δ}^{{k}_{i}} , \qquad ( 8 )$$

where, hᵢ is the complex path gain in i-th path, here τᵢ and vᵢ be the delay and Doppler shift associated with the i-th path;
wherein the normalized delay and Doppler shift index for the i-th path are given by lᵢ=τᵢUΔf, kᵢ=vᵢVT, where Δf=1/T is subcarrier space and the practical delays and Doppler frequency shifts are approximated to the nearest points of the grid in the DD domain;
wherein the channel matrix Π^{l}^{ᵢ} as the permutation matrix (forward cyclic shift), and Δ^{k}^{ᵢ}=diag(z⁰, z¹, . . . , z^{UV-1}) with z=exp(j2π/UV) models the delay and Doppler shifts, respectively.

In the present system, the OTFS demodulator 150 at the receiver operates on received time-domain signal passes to get back the DD domain representation of transmitted information, where the input-output relation in the DD domain of IoT is given as

$$y = ( {F}_{V} ⊗ {I}_{U} ) r = {H}_{eff} {\overline{x}}_{I / Q} + w , \qquad ( 9 )$$

here

$${H}_{eff} = ( {F}_{V} ⊗ {I}_{U} ) H ( {F}_{V}^{H} ⊗ {I}_{U} )$$

is the effective channel matrix of size UV×UV. w=(F_{V}⊗I_{U})\acute{w} preserves the same statistical properties of \acute{w}.

In the present system, the minimum mean squared error (MMSE) equalizers 160 at the receiver equalized the received signal with perfect channel state information, where the equalized information is expressed as

$${\tilde{x}}_{I / Q} = {( {E}_{eff}^{H} {H}_{eff} + {σ}^{2} {I}_{UV} )}^{- 1} {H}_{eff}^{H} y . \qquad ( 10 )$$

In the present system, the N-D converter 440 or 540 performs the inverse operation of the I/Q converter 220 and produces \tilde{X}_{I/Q}, and the N-D signal de-mapper 450 or 550 demaps the symbol points in the N-D constellation using minimal distance judgment which is given as

$${\tilde{X}}_{N - D} ( p ) = arg {max}_{{p}_{q} ∈ {Q}_{N - D}} \vert {p}_{q} - {\tilde{X}}_{I / Q} ( p ) \vert . \qquad ( 11 )$$

where the detected symbols are converted back to a stream of bits and the DL-SCH/UL-SCH decoder 180 subsequently decodes these information bits, reproducing the sent information bits.

### BRIEF DESCRIPTION OF THE DRAWINGS

FIG. 1 Block diagram of the ND-OTFS-Based IoT system model.

FIG. 2 Modified PDSCH block.

FIG. 3 Modified PUSCH block.

FIG. 4 Modified PDSCH Decoding block,

FIG. 5 Modified PUSCH Decoding block.

FIG. 6 3-D signal constellations for different modulation order.

FIG. 7 ND-4QAM-OTFS-based IT system performance with the vehicular speed of 500 Km/h in EVA channel.

FIG. 8 ND-16QAM-OTFS-based IT system performance with the vehicular speed of 500 Km/h in EVA channel.

FIG. 9 3D-OTFS-based IoT system performance at different modulation order with the vehicular speed of 500 Km/h in different channel model.

FIG. 10 ND-OTFS-based IoT system performance at different modulation order with the vehicular speed of 500 Km/h in mmWave channel model.

### DETAILED DESCRIPTION OF THE INVENTION

The disclosure provides a coding and modulation apparatus that increases the bit error rate performance of the Internet of Things (IoT) or machine-to-machine (M2M) system at high Doppler shift. A further objective is to provide a demodulation and decoding apparatus and method. The said system encodes the information bits using Q-order N-Dimensional (N-D) constellations and modulates the delay-Doppler (DD) symbols with an orthogonal time frequency space (OTFS) modulation technique. So, the said system is termed the ND-OTFS-based IoT system, which is compatible with 5G and beyond. The constellation points of the Q-order N-D signal mapper have been optimized by searching the points in the search region and ensuring the symbol's total power as unity.

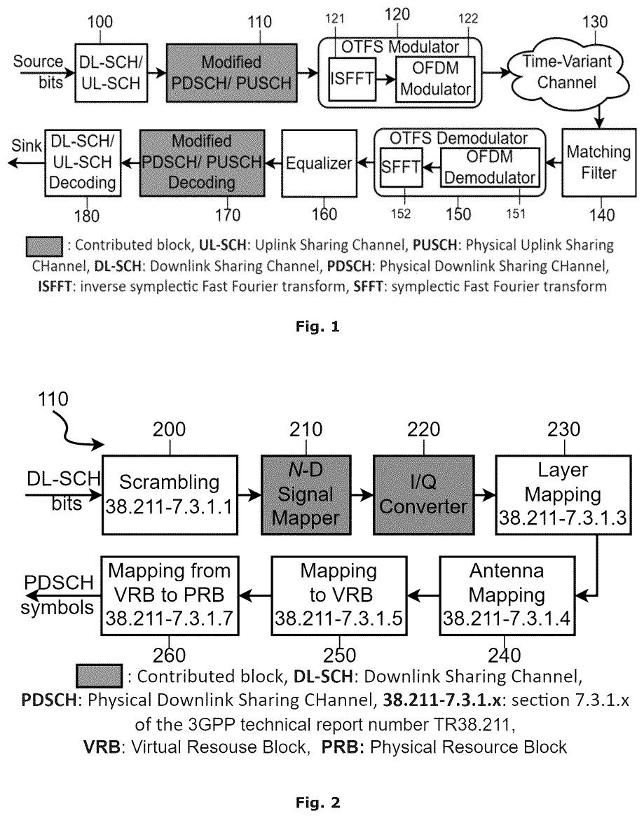

The said system is developed by following the 3GPP standardization with the inventive blocks as highlighted (shaded blocks) in FIG. 1. To have reliability and immunity against mobility, the IoT and M2M system uses OTFS modulation instead of OFDM modulation with the N-D signal mapper. The embodiment supports both uplink and downlink communication systems.

Referring to the drawings, wherein reference numerals designate identical or corresponding parts throughout the several views, FIG. 1 shows an embodiment of the transceiver apparatus of the ND-OTFS-based IoT system. A downlink communication system comprises DL-SCH (Downlink Sharing Channel) 100, followed by a modified PDSCH (Physical Downlink Sharing CHannel) 110, and an OTFS modulator 120 that maps the DD domain information symbol to the time domain samples. Said OTFS modulator 120 is configured to treat the input symbols as in the delay Doppler domain; based on the total number of delay samples and Doppler samples (V), information symbols were arranged in a matrix of size (U×V). Inverse symplectic Fast Fourier transform (ISFFT) 121 is applied to obtain the time-frequency samples of the information symbols. The time domain samples are obtained by the OFDM modulator 122. The time-modulated signal passes through the time-varying channel 130. The signal received undergoes the matching filter 140 and then the OTFS demodulator 150. Said OTFS demodulator 150 uses OFDM demodulator 151 to retrieve the time-frequency domain samples, and then symplectic Fast Fourier transform (SFFT) 152 is applied to get back to the DD domain. The said system then equalizes the information symbols in the DD domain using the equalizer 160. In the end, information symbols passed through the modified PDSCH decoder 170 and DL-SCH decoder 180 to get back the information bits.

However, in an uplink communication system, it comprises UL-SCH (Uplink Sharing Channel) 100, followed by a modified PUSCH (Physical Uplink Sharing Channel) 110, and an OTFS modulator 120 that maps the DD domain information symbol to the time domain samples. Said OTFS modulator 120 is configured to treat the input symbols as in the delay Doppler domain; based on the total number of delay samples and Doppler samples (V), information symbols were arranged in a matrix of size (U×V). Where ISFFT 121 is applied to have the time-frequency samples of the information symbols. The time domain samples are obtained by the OFDM modulator 122. The time-modulated signal passes through the time-varying channel 130 in the uplink communication. At the base station, the received signal undergoes the matching filter 140 and then the OTFS demodulator 150. Said OTFS demodulator 150 uses OFDM demodulator 151 to retrieve the time-frequency domain samples, and then SFFT 152 is applied to get back to the DD domain. The said system then equalizes the information symbols in the DD domain using the equalizer 160. In the end, information symbols passed through the modified PUSCH decoder 170 and UL-SCH decoder 180 to get back the information bits.

As per release 18, the DL-SCH block 100 contains intermediate blocks like transport block-cyclic redundancy check (CRC) attachment, Low-Density Parity Check (LDPC) graph selection, code block segmentation, channel coding, rate matching, and code block concatenation. In the literature, Reddy et al (US 2023/0370316-A1) showed that LDPC channel encoding could be removed using OTFS modulation for the new radio IoT (NR-IoT) system. So, in the system model, the intermediate blocks related to the LDPC coding have been removed, simplifying the transmitter design. The corresponding receiver design, DL-SCH decoder 180, is also free from the complex LDPC decoder. So, at the receiver end, the devices conserve the energy required for the LDPC decoder.

Like the DL-SCH block, the intermediate blocks related to the LDPC coding have been removed in the UL-SCH block 100. As a reflection, the corresponding receiver design, UL-SCH decoder 180, is also free from the complex LDPC decoder.

The modified PDSCH block 110 comprises scrambling 200 that scrambles the input bits using gold sequences as defined in TR-38.211, N-D signal mapper 210 maps the information symbols to N-D space using N-D constellations, I/Q converter 220 transforms the N-D signal mapped matrix into a complex vector, layer mapping 230 that distribute the symbols into multiple layers depending upon the device settings, antenna port mapping 240 that maps each layer to respective antenna ports, mapping to a virtual resource block (VRB) 250 creates virtual resource grid by arranging the symbols in delay-first, Doppler second method, and VRB to a physical resource block (PRB) 260 maps each VRB to PRB with interleaved mapping or non-interleaved method. The selection of the number of layers and mapping VRB to PRB differs from vendor to vendor, and the same information is passed to the device through the control plane.

The number in each box of FIG. 2 represents the 3GPP technical specification number TR38.211, followed by the section that contains the detailed description of the block.

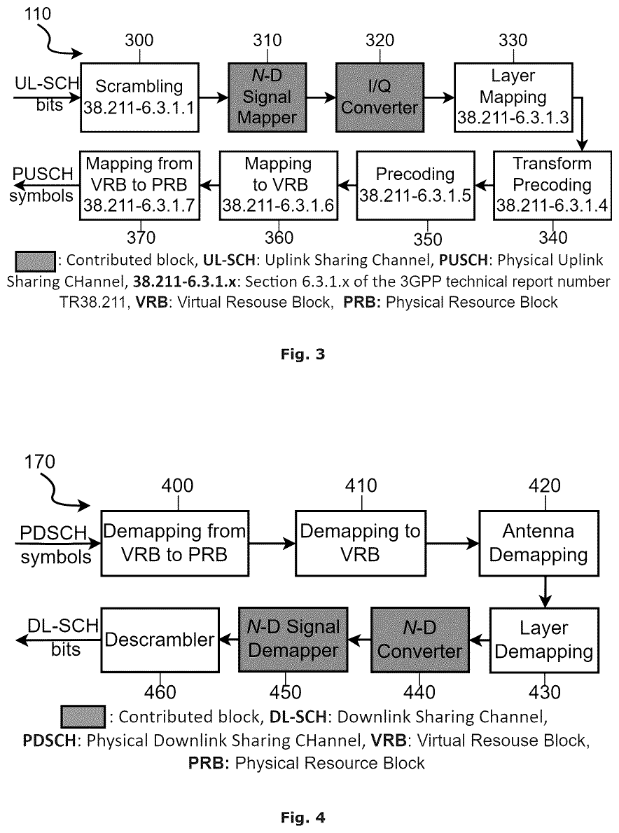

For the uplink communication 110 is activated with the modified PUSCH block, which comprises scrambling 300 that scrambles the input bits to ensure the uniform power distribution across different frequency and time resources, N-D signal mapper 310 maps the information symbols to N-D space using N-D constellations, I/Q converter 320 transforms the N-D signal mapped matrix into a complex vector, layer mapping 330 that distribute the symbols into multiple layers depending upon the device settings, transform precoding 340 that converts the data into the forms of DFT-s-OFDM format depending upon the number of layers and the number of antenna ports, precoding block 350 multiplies a precoding matrix to the data, mapping to a VRB 360 creates a virtual resource grid by arranging the symbols in delay-first, Doppler second method, and VRB to a PRB 370 maps each VRB to PRB with interleaved mapping or non-interleaved method. The selection of the number of layers and mapping VRB to PRB differs from vendor to vendor, and the same information is passed to the device through the control plane. The number in each box of FIG. 3 represents the 3GPP technical specification number TR38.211, followed by the section that contains the detailed description of the block.

As shown in FIG. 1, the present disclosure comprises one transmission apparatus and one receiving apparatus either in an uplink or downlink communication system. In other embodiments of transmission apparatus, additional elements may be provided, such as input processing circuitry, frame building circuitry, and/or different waveform generation circuitry, e.g., zero padded OTFS, orthogonal time sequency multiplexing, or any other variant of the OTFS modulation. In other embodiments of the receiver apparatus, more receiving apparatus with multiple receiving antennae can be provided.

Generally, data (e.g. communication data, broadcast data, etc.) shall be transmitted from a transmission apparatus to one said receiving apparatus over a time-varying channel. Moreover, in other embodiments, the channel can be multicast, or broadcast and may be employed as a one-directional or bi-directional, and may be relayed (with amplify and forward, decode and forward).

The transmitter generally targets a particular scenario. For instance, a payload size of A is intended to be transmitted to an IoT device, or the payload is requested by the IoT device during the active mode of operation. The said payload A will go through the DL-SCH in the downlink and UL-SCH in the uplink, where b_{CRC} bits are attached and processed further in the DL-SCH/UL-SCH block 100 and passed to the modified PDSCH/PUSCH block 110. The information bits get scrambled here with the gold sequences at 200 or 300. These scrambled bits dₛ=(b₀, b₁, . . . , bₚ) passed through the N-D signal mapper 210 or 310 for downlink and uplink, respectively, where the size of the scrambled bit is given as p=2UV log₂ Q/N.

### Method to Find the Q-Order N-D Signal Constellation

The higher dimensional signal constellation only finds the Q points in a N-dimensional space to maximize the minimum pairwise Euclidean distance. These Q points are mapped to the Q-order signal constellation. Let us represent the Q points in the N-dimensional plane. Each point p_{q} is represented by a N-dimensional vector of coordinates: p_{q}=(α_{q1}, α_{q2}, . . . , α_{qN}), where q=1, 2, . . . , Q. The Euclidean distance between points pₘ and pₙ is given as

$$d ( {p}_{m} , {p}_{n} ) = \sqrt{{( {α}_{m 1} - {α}_{n 1} )}^{2} + {( {α}_{m 2} - {α}_{n 2} )}^{2} + … + {( {α}_{mN} - {α}_{nN} )}^{2}} \qquad ( 1 )$$

To maximize the minimum Euclidean distance between the Q points, we have formulated the optimization problem as

$${max}_{p ∈ ℤ} min ( d ( {p}_{m} , {p}_{n} ) ) \qquad ( 2 a )$$

$$s . t . - 1 \leq {α}_{qt} \leq 1 ∀ q ∈ Q , t ∈ N , \qquad ( 2 b )$$

$$d ( {p}_{m} , {p}_{n} ) \geq c ∀ m \neq n , \qquad ( 2 c )$$

$${\sum }_{n = 1}^{N} {α}_{qt} \neq 0 ∀ q ∈ Q \qquad ( 2 d )$$

Here, the constraint (2b) restricts the values of the variables to be between −1 and 1 for all q∈Q, and t∈M or N. The minimum required Euclidean distance between two distinct points, pₘ and pₙ is assigned a lower boundary to ensure non-zero entry (2c). The constraints (2d) ensure that the optimized points have no origin.

Unfortunately, finding the optimal solution for the described optimization problem is computationally challenging, as the number of points Q and dimensionality increases significantly. The problem belongs to the class of NP-hard problems. In such cases, solving the problem using a brute-force approach or a direct optimization method is not practical. Instead, approximate algorithms or heuristics can be employed to find suboptimal solutions. So, a heuristic method, a Genetic Algorithm, is used to solve the optimization problems. Let Q_{N-D}∈R^{Q×N} is the optimized points which are mapped to Q-order signal constellation and are represented as

$${Q}_{N - D} = [ \begin{matrix}{β}_{11} & {β}_{21} & … & {β}_{Q 1} \\ {β}_{12} & {β}_{22} & & {β}_{Q 2} \\ ⋮ & & ⋱ & ⋮ \\ {β}_{1 N} & {β}_{2 N} & … & {β}_{QN}\end{matrix} ] . \qquad ( 3 )$$

FIG. 6 shows the 3-D constellation for 4-QAM, 16-QAM, 64-QAM, and 256-QAM. Similarly, we can design the higher dimensional constellations for each modulation order by solving (2). The N-D signal constellations of different modulation orders have the same symbol power; that is to say, the average power of different constellations is normalized, which makes comparisons between constellations fair and meaningful.

In the following, the position vector obtained by use of the above-described method for obtaining N-dimensional constellations is presented below

TABLE I
Vector position of the {3, 4, 5} dimensional 4QAM constellation

| Bit label: b₁b₀ | 3-D | | 4-D | | 5-D | | |
|---|---|---|---|---|---|---|---|
| 00 | 0.5774 | −0.5774 | 0.5 | −0.5 | 0.4472 | −0.4472 | 0.4472 |
| | −0.5774 | | 0.5 | 0.5 | −0.4472 | 0.4472 | |
| 01 | 0.5774 | 0.5774 | 0.5 | 0.5 | −0.4472 | 0.4472 | −0.4472 |
| | 0.5774 | | −0.5 | 0.5 | 0.4472 | 0.4472 | |
| 11 | −0.5774 | 0.5774 | −0.5 | 0.5 | −0.4472 | −0.4472 | −0.4472 |
| | −0.5774 | | 0.5 | −0.5 | −0.4472 | −0.4472 | |
| 10 | −0.5774 | −0.5774 | −0.5 | −0.5 | 0.4472 | 0.4472 | 0.4472 |
| | 0.5774 | | −0.5 | −0.5 | 0.4472 | −0.4472 | |

TABLE II
Vector position of the {3, 4, 5} dimensional 16-QAM constellation

| Bit label: | | | | | | | |
|---|---|---|---|---|---|---|---|
| b₃b₂b₁b₀ | 3-D | | 4-D | | 5-D | | |
| 0000 | 0.7559 | −0.5544 | −0.5164 | 0.5164 | 0.1022 | 0.4967 | −0.4991 |
| | −0.7257 | | −0.5164 | 0.5164 | 0.4901 | 0.3900 | |
| 0001 | −0.7559 | 0.7559 | 0.5164 | 0.5164 | 0.4991 | 0.4956 | 0.4991 |
| | 0.2510 | | 0.5164 | 0.5164 | 0.0679 | 0.4911 | |
| 0011 | 0.7559 | −0.5020 | 0.5164 | −0.5164 | 0.4982 | 0.4563 | −0.4991 |
| | 0.1830 | | −0.5164 | 0.5164 | −0.4881 | −0.0599 | |
| 0010 | 0.0200 | 0.7559 | 0.5164 | −0.5164 | 0.0769 | 0.4991 | 0.4871 |
| | 0.7559 | | −0.5164 | −0.5164 | −0.4991 | −0.4938 | |
| 0100 | −0.7559 | −0.7559 | −0.5164 | −0.5164 | 0.4991 | 0.4905 | 0.1088 |
| | −0.7519 | | −0.5164 | 0.5164 | 0.4991 | −0.4991 | |
| 0101 | −0.7559 | 0.0005 | 0.5164 | −0.5164 | 0.4991 | −0.4991 | −0.4940 |
| | 0.7559 | | 0.5164 | −0.5164 | −0.1225 | 0.4988 | |
| 0111 | −0.0013 | 0.0012 | 0.5164 | −0.5164 | −0.4991 | 0.4991 | 0.4951 |
| | −0.7559 | | 0.5164 | 0.5164 | 0.4925 | −0.0843 | |
| 0110 | 0.0039 | −0.7559 | −0.5164 | −0.5164 | 0.4991 | −0.4959 | −0.4991 |
| | −0.2563 | | 0.5164 | 0.5164 | 0.4969 | −0.4991 | |
| 1000 | −0.7505 | −0.7559 | −0.5164 | −0.5164 | −0.4991 | −0.0706 | −0.4991 |
| | 0.2487 | | −0.5164 | −0.5164 | −0.4991 | 0.4805 | |
| 1001 | −0.0014 | 0.7559 | −0.5164 | 0.5164 | 0.0406 | −0.4914 | 0.4730 |
| | −0.2525 | | 0.5164 | −0.5164 | 0.4643 | 0.4898 | |
| 1011 | 0.0039 | 0.0003 | −0.5164 | 0.5164 | −0.4991 | 0.4991 | 0.4991 |
| | 0.2541 | | 0.5164 | 0.5164 | −0.4991 | 0.4991 | |
| 1010 | −0.7559 | 0.0013 | −0.5164 | 0.5164 | 0.4926 | −0.4991 | 0.4615 |
| | −0.2525 | | −0.5164 | −0.5164 | −0.4752 | −0.0862 | |
| 1100 | −0.7559 | 0.7559 | 0.5164 | 0.5164 | −0.4886 | −0.4991 | −0.4974 |
| | −0.7559 | | −0.5164 | −0.5164 | 0.4991 | 0.1025 | |
| 1101 | 0.0401 | −0.7559 | 0.5164 | 0.5164 | −0.4682 | 0.4991 | −0.4991 |
| | 0.7559 | | −0.5164 | 0.5164 | −0.0087 | −0.4722 | |
| 1111 | 0.7559 | 0.2625 | −0.5164 | −0.5164 | −0.0794 | −0.4980 | −0.4451 |
| | −0.3303 | | 0.5164 | −0.5164 | −0.4948 | −0.4991 | |
| 1110 | 0.7559 | 0.2138 | 0.5164 | 0.5164 | −0.4913 | −0.4867 | 0.4972 |
| | 0.7559 | | 0.5164 | −0.5164 | 0.0156 | −0.4953 | |

Similarly, we can develop the constellation vectors for all other modulations using the method described.

In addition, not only a constellation from the above-described constellations may be selected and used by the modulator and demodulator, but also a transformed version of such an N-dimensional constellation of said group of constellations may be selected and used. Such a transformed version may be obtained from any of said constellations through a transformation including a rotation by an angle around the origin, an inversion of bit labels for all constellation points, an interchanging of bit positions, and/or a pre-distortion for the constellation points.

TABLE III
The minimum Euclidean distances (MED)
of N-D signal constellations

| Modulation | Constellation | | MED increment | |
|---|---|---|---|---|
| order | dimension | MED | w.r.t. 2D | SE |
| 4 | 2D | 1.4142 | | 2 |
| | 3D | 1.6330 | 15.47 | 1.7233 |
| | 4D | 1.4142 | 0 | 1.5 |
| | 5D | 1.5492 | 9.55 | 1.3288 |
| 16 | 2D | 0.6227 | — | 4 |
| | 3D | 0.9071 | 45.67 | 3.0566 |
| | 4D | 1.0328 | 65.85 | 2.5 |
| | 5D | 1.1478 | 84.33 | 2.1288 |
| 64 | 2D | 0.2813 | — | 6 |
| | 3D | 61.18 | 4.3900 | 0.5684 |
| | 4D | 0.5684 | 102.06 | 3.5 |
| | 5D | 0.6058 | 115.38 | 2.9288 |
| 256 | 2D | 0.1323 | — | 8 |
| | 3D | 0.2819 | 115.80 | 5.7233 |
| | 4D | 0.4135 | 212.55 | 4.5 |
| | 5D | 0.5053 | 281.18 | 3.7288 |

Table III shows the MEDs and the spectral efficiency (SE) of N-D constellations for different modulation orders. The table also shows the percentage (%) increment of the MED concerning the 2D constellation for each modulation order. The average power of unity is raised to the same degree for all signal constellations. To maintain the constant frame size of the IoT device, the number of symbols assigned to it in the DD domain is kept consistent with the change of modulation order and the constellation dimension. So, the spectral efficiency decreases with the increase in the constellation dimension. Moreover, the MED of the 3-D constellation is about 15.47% larger than that of the 4-QAM or QPSK constellation when the modulation order is 4. However, it does not show significant improvement at the higher dimension as the number of constellation points limits 4-QAM, and the order of dimension gets more elevated than the modulation order. Due to more points in the constellation being powered by the same average power and a smaller increment percentage, MEDs for N-D constellations decrease as the modulation order is raised to 16. While the MEDs of N-D constellations for N>2 continue to drop as the modulation order increases from 16 to 256, the rate at which N-D MEDs increase over 2-D MEDs increases. As a result, our proposed ND-OTFS-based IoT system and other digital communication systems can benefit significantly from improved BER performance with the higher-order modulation of different constellation dimensions. It demonstrates how much better the ND-OTFS system is than the traditional OTFS system by comparing the increment ratio of the MED under different modulation orders. We can observe that with the increase in modulation order and dimensions, the increment ratio of MED is rising, reflecting improved BER performances of the ND-OTFS-based IoT system.

In the N-D signal mapper 210 or 310, bits are arranged in N-parallel lines, and then each column is mapped to a symbol from the Q symbol. The Q-order N-D signal mapper maps the bits, which is given as

$${X}_{N - D} = [ \begin{matrix}{β}_{11} & {β}_{21} & … & {β}_{p 1} \\ {β}_{12} & {β}_{22} & & {β}_{p 2} \\ ⋮ & & ⋱ & ⋮ \\ {β}_{1 N} & {β}_{2 N} & … & {β}_{pN}\end{matrix} ] . \qquad ( 4 )$$

An I/Q converter 220 or 320 generates the I/Q samples from the X_{N-D} that can be transmitted in a digital communication system. The expression for the I/Q converter is given as

$${x}_{I / Q} ( i ) = {x}_{N - D} ( 2 i ) + {jx}_{N - D} ( 2 i + 1 ) , \qquad ( 5 )$$

where X_{N-D}=vec(X_{N-D}). Then, the I/Q samples are processed through layer mapping 230 or 330. In the downlink communication, the data is then passed through the antenna mapping 240. However, in the uplink communication system, the layer data passes through the transform precoding 340 and precoding 350. Then, the data symbols are mapped to VRB 250 or 360 and mapped from VRB to PRB 260 or 370 for downlink and uplink, respectively. At the end of the modified PDSCH/PUSCH block 110, we will have the information symbols x̅_{I/Q} treated as in the Delay-Doppler domain.

These symbols are arranged in an adaptive OTFS frame S∈C^{U×V}. The transmitted time-domain signal for OTFS modulation 120 in vector form can be written as

$$s = ( {F}_{V}^{H} ⊗ {I}_{U} ) {\overline{x}}_{I / Q} , \qquad ( 6 )$$

We assume channel 130 has a memory length of L, so CP of length (L−1) is added to S before transmission. The received signal after discarding the CP can be written as

$$r = Hs + {w}^{′} , \qquad ( 7 )$$

where \acute{w} is the AWGN in the time domain and H is the UV×UV channel matrix with P multipath defined as

$$H = {\sum }_{i = 1}^{P} {h}_{i} {\prod }^{{l}_{i}} {Δ}^{{k}_{i}} , \qquad ( 8 )$$

where, hᵢ is the complex path gain in i-th path. Let τᵢ and vᵢ be the delay and Doppler shift associated with the i-th path. Then the normalized delay and Doppler shift index for the i-th path are given by lᵢ=τᵢUΔf, kᵢ=vᵢVT, where Δf=1/T is subcarrier space. The practical delays and Doppler frequency shifts are approximated to the nearest points of the grid in the DD domain. In the channel matrix Π^{l}^{ᵢ} as the permutation matrix (forward cyclic shift), and Δ^{k}^{ᵢ}=diag(z⁰, z¹, . . . , z^{UV-1}) with z=exp(j2π/UV) models the delay and Doppler shifts, respectively.

At the receiver, the received time-domain signal passes through the OTFS demodulator 150 to get back the DD domain representation of transmitted information. So, the input-output relation in the DD domain of IoT is given as

$$y = ( {F}_{V} ⊗ {I}_{U} ) r = {H}_{eff} {\overline{x}}_{I / Q} + w , \qquad ( 9 )$$

where

$${H}_{eff} = ( {F}_{V} ⊗ {I}_{U} ) H ( {F}_{V}^{H} ⊗ {I}_{U} )$$

is the effective channel matrix of size UV×UV. w=(F_{V}⊗I_{U})\acute{w} preserves the same statistical properties of \acute{w}.

The received signal is equalized with traditional minimum mean squared error (MMSE) equalizers 160 with perfect channel state information. So, the equalized information is expressed as

$${\tilde{x}}_{I / Q} = {( {H}_{eff}^{H} {H}_{eff} + {σ}^{2} {I}_{UV} )}^{- 1} {H}_{eff}^{H} y . \qquad ( 10 )$$

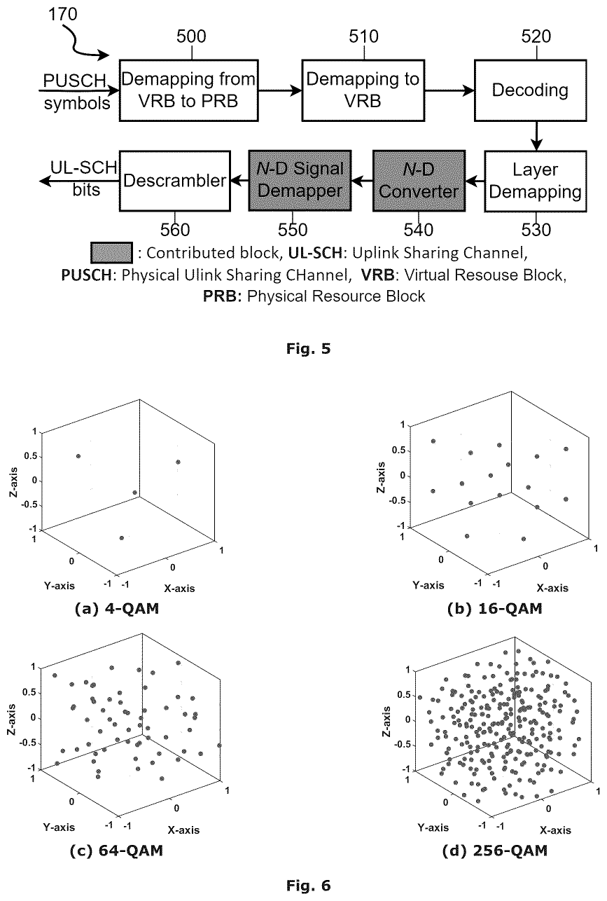

At the end of detection, the information symbols are rearranged into vector form and passed through the modified PDSCH decoder 170 in the downlink system. The intermediate blocks of the modified PDSCH decoder 170 are shown in FIG. 4. For the uplink system, the intermediate blocks for the modified PUSCH decoder 170 are shown in FIG. 5. The N-D converter 440 or 540 performs the inverse operation of the I/Q converter 220 and produces \tilde{X}_{I/Q}, and the N-D signal de-mapper 450 or 550 demaps the symbol points in the N-D constellation using minimal distance judgment which is given as

$${\tilde{X}}_{N - D} ( p ) = arg {max}_{{p}_{q} ∈ {Q}_{N - D}} \vert {p}_{q} - {\tilde{X}}_{I / Q} ( p ) \vert . \qquad ( 11 )$$

The detected symbols are converted back to a stream of bits. The DL-SCH/UL-SCH decoder 180 subsequently decodes these information bits, reproducing the sent information bits. As the LDPC-related blocks are removed in the DL-SCH/UL-SCH decoder 180, it comprises only three parts: de-mapper, descrambling, and CRC removal. At the end of the procedure, the IoT or base station receives the required information in the downlink or uplink communication, respectively.

### Advantages:

i. The heavily low complex transceiver design is energy-efficient, cost-effective, and reliable for IoT/M2M deployment in high-vehicle speed/high-mobility environments.
ii. The proposed transceiver design is applicable to establish a link in resource-constrained devices with variable speeds.
iii. The intra and inter-vehicular communication for infotainment services and transport road traffic information can be enhanced using the proposed transceiver.
iv. The designed system supports any static IoT device trying to communicate with a 5G network and beyond.
v. The designed ND-OTFS modulation enhances the reliability with less receiver complexity.
vi. The generic multi-dimensional signal constellation generation technique can be used by any wireless communication system for symbol mapping.

### Results and Discussion

In this section, we illustrate the performance in terms of BER of the uncoded ND-OTFS-based IoT system in the sub-6 and mmWave frequency bands with the perfect CSI. The number of OFDM symbols V=14 and subcarriers U=12 is taken for the simulation. The carrier frequency is either 4 GHz or 28 GHZ, and the subcarrier spacing is 15 kHz. The information symbol is modulated by Q modulation order in different dimensions. For the channel model, we adopt the power delay profile of the Extended Vehicular A model (EVA), Extended Pedestrian A model (EPA), and Extended Typical Urban model (ETU). The mmWave channel model was simulated according to the tapped delay line (TDL)-B model of 3GPP in NLoS and LoS scenarios, respectively, with a delay spread of 66 ns. Each delay tap has a single Doppler shift generated using Jake's formula: vᵢ=vₘₐₓ cos(θᵢ), where vₘₐₓ is the maximum Doppler shift determined by the IoT device speed and θᵢ is uniformly distributed over [−π, π]. The system is evaluated at extreme Doppler shift conditions, so at lower Doppler shifts, the proposed system will show improved or near-extreme Doppler situations.

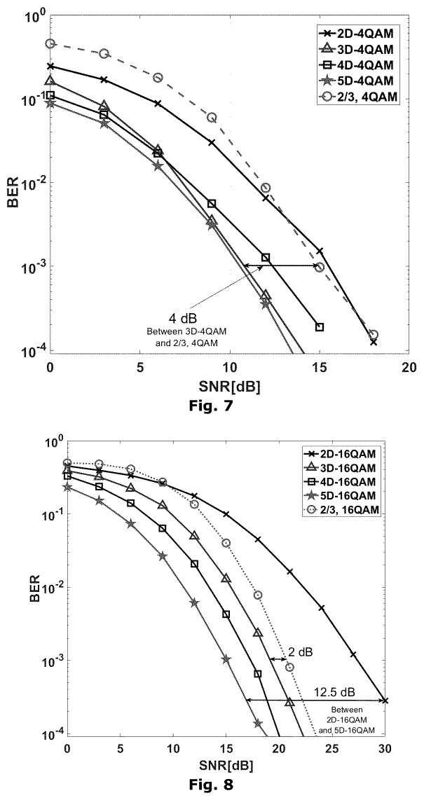

The BER performance of the proposed ND-OTFS-based IoT system at different signal constellation dimensions with 4-QAM and 16-QAM constellations in the EVA channel at a maximum vehicle speed of 500 km/h is shown in FIG. 7 and FIG. 8, respectively. The power efficiency per bit is improved with the increase in MED due to the rise in constellation dimension, which can be seen in the BER performances. The simulation results show that the BER performance is improving significantly with the increase in the signal constellation dimension for both 4-QAM and 16-QAM. With the 16-QAM constellation, the ND-OTFS-based IoT shows significant improvement as the MED has increased significantly with the constellation dimension. Our proposed system shows 4 dB and 12.5 dB SNR gain to achieve a BER of 3×10⁻⁴ with 5D-4QAM and 5D-16QAM, respectively, compared to the traditional system. Whereas the proposed system with the 4D-QAM performs poorly for SNR>6.5 dB compared to the 3D-QAM system as it has a minimum MED gain compared to the MED of the 3D-QAM. Moreover, we can observe that the proposed system with 4D-QAM shows a 3 dB offset from the traditional system. The gain is due to the translation of the constellation dimension. To show the superiority of the proposed system, we have also compared the system with the convolutional-system with the same code rate gains 4 dB and 2 dB over the coded OTFS-based IoT system with the 4-QAM and 16-QAM modulations, respectively, to achieve a BER of 10⁻³. The convolutional encoder/decoder costs more hardware resources, whereas a multi-dimensional QAM is a simple look-up table. The simulation findings show that the proposed scheme outperforms the current OTFS-based IoT system over the EVA channel, notably for higher-dimensional constellations.

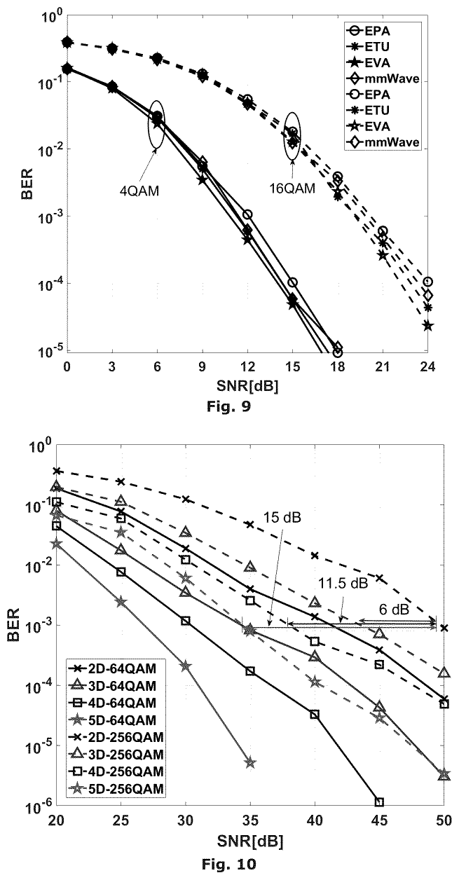

The resilience of the proposed ND-OTFS-Based IoT system to the ETU, EVA, EPA, and mmWave channel at a vehicle speed of 500 Km/h is shown in FIG. 9. The system is evaluated here with the 4-QAM and 16-QAM at 3D constellations dimension. It can be delivered from the figure that in every channel condition with as high as Doppler due to 500 Km/h, the system can establish a link with the IoT device at low SNRs. The proposed system with the 4-QAM and 16-QAM shows a 1.5 dB gain in the EVA channel compared to the EPA channel to achieve a BER of 10⁻³. Whereas the system performance in the ETU and mmWave at high Doppler lies in between the EVA channel and EPA channel performance. The simulation findings show that the proposed system has notable similar performance over every channel model with high Doppler shifts, like at a 500 Km/h vehicular speed.

To show the elasticity of the proposed system, we have evaluated the BER performance of the ND-OTFS-Based IoT system at 64-QAM and 256-QAM constellations with the variation in constellation dimension in the mmWave channel at a maximum vehicle speed of 500 km/h is shown in FIG. 10. The carrier frequency is taken as 28 GHz. When the constellation dimension is 5-D, the BER of the proposed system with the MMSE equalizer is 1075 at an SNR of 34 dB and 47 dB with the modulation order of 64-QAM and 256-QAM, respectively. It is worth noting that with the increase in the constellation dimension, the BER performance of the proposed system shows improvement over the higher modulation orders. The proposed system with 256-QAM shows a gain of 6 dB, 11.5 dB, and 15 dB as the dimension increases from 2 to 3, 4, and 5, respectively, to achieve a BER of 10⁻³. The simulation findings show that the proposed system outperforms the current OTFS-based IoT system, notably for larger modulation orders, over the mmWave channel also.

We claim:

1. A low-complex, reliable multidimensional orthogonal time-frequency space (ND-OTFS) modulation-based communication system for uplink and downlink wireless communication between resource-constrained Internet of Things (IoT) and machine-to-machine (M2M) devices comprising
at least one transmitter configured to transmit bit stream involving N-Dimensional (N-D) signal mapper and OTFS frame; and
at least one receiver configured to be integrated into said IoT or M2M devices, featuring a low-complexity detector for receiving the transmitted bit stream.

2. The system as claimed in claim 1, wherein the downlink (DL) or uplink (UL) wireless communication transmitter for a multi-dimensional transceiver apparatus of the ND-OTFS-based IoT and M2M devices includes
a DL-SCH (Downlink Sharing Channel) or UL-SCH (Uplink Sharing Channel) 100;
a PDSCH (Physical Downlink Sharing Channel) or PUSCH (Physical Uplink Sharing Channel) 110, and
an OTFS modulator 120 that maps DD (Delay Dopler) domain information symbol to time domain samples.

3. The system as claimed in claim 2, wherein said OTFS modulator 120 is configured to treat the input symbols as in the DD domain and based on total number of delay samples and Doppler samples (V), information symbols are arranged in a matrix of size (U×V);
said OTFS modulator 120 includes
an Inverse symplectic Fast Fourier transform (ISFFT) 121 unit to obtain the time-frequency samples of the information symbols;
an OFDM modulator 122 unit to obtain the time domain samples, whereby the time-modulated signal passes through a time-varying channel 130.

4. The system as claimed in claim 1, wherein the downlink wireless communication receiver for a multi-dimensional transceiver apparatus of the ND-OTFS-based IoT systems includes
a matching filter 140 to detect the presence of transmitted template in the unknown signal;
an OTFS demodulator 150 including
an OFDM demodulator 151 to retrieve the time-frequency domain samples, and
a symplectic Fast Fourier transform (SFFT) unit 152 to get back to the DD domain;
an equalizer 160 to equalizes the information symbols in the DD domain; and
a PDSCH or PUSCH decoder 170 and a DL-SCH or UL-SCH decoder 180 to get back the information bits.

5. The system as claimed in claim 2, wherein the PDSCH block 110 comprises
a scrambling unit 200 that scrambles the input bits using gold sequences as defined in TR-38.211;
a N-D signal mapper 210 that maps the information symbols to N-D space using N-D constellations;
an I/Q converter 220 that transforms the N-D signal mapped matrix into a complex vector;
a layer mapping 230 that distribute the symbols into multiple layers depending upon the device settings;
an antenna port mapping 240 that maps each layer to respective antenna ports, mapping to a virtual resource block (VRB) 250 that creates virtual resource grid by arranging the symbols in delay-first, Doppler second method; and
a VRB to physical resource block (PRB) mapper 260 that maps each VRB to PRB with interleaved mapping or non-interleaved method, whereby selection of the number of layers and mapping VRB to PRB differs from vendor to vendor, and the same information is passed to the device through the control plane.

6. The system as claimed in claim 2, wherein the PUSCH block 110 comprises
a scrambling unit 300 that scrambles the input bits to ensure the uniform power distribution across different frequency and time resources;
a N-D signal mapper 310 that maps the information symbols to N-D space using N-D constellations;
an I/Q converter 320 that transforms the N-D signal mapped matrix into a complex vector;
a layer mapping 330 that distribute the symbols into multiple layers depending upon the device settings;
a transform precoding 340 that converts the data into the forms of DFT-s-OFDM format depending upon the number of layers and the number of antenna ports;
a precoding block 350 multiplies a precoding matrix to the data, mapping to a VRB 360 creates a virtual resource grid by arranging the symbols in delay-first, Doppler second method; and
a VRB to a PRB mapper 370 that maps each VRB to PRB with interleaved mapping or non-interleaved method, wherein the selection of the number of layers and mapping VRB to PRB differs from vendor to vendor, and the same information is passed to the device through the control plane.

7. The system as claimed in claim 1, wherein the IoT or M2M devices are configured to send a request to register themselves in control channel network at a given time instant when the devices are required to transmit or receive any information, including exchanging the status of the devices with the base station and information about the mobility condition including current speed through Random-Access Channel, whereby a change in speed during the communication is shared through an uplink control channel.

8. The system as claimed in claim 2, wherein a payload size of A which is intended to be transmitted to the IoT device or the payload is to be requested by the IoT device during an active mode of operation, said payload A go through the DL-SCH in the downlink and UL-SCH in the uplink, as applicable where b_{CRC} bits are attached and processed further in the DL-SCH/UL-SCH block 100 and passed to the modified PDSCH/PUSCH block 110 and the information bits get scrambled here with gold sequences at 200 or 300, whereby these scrambled bits dₛ=(b₀, b₁, . . . , bₚ) passed through the N-D signal mapper 210 or 310 for downlink and uplink, respectively, where the size of the scrambled bit is given as p=2UV log₂ Q/N.

9. The system as claimed in claim 8, wherein the N-D signal mapper 210 or 310 find the Q-order N-D signal constellation involving
finding the Q points in a N-dimensional space to maximize the minimum pairwise Euclidean distance;
mapping the Q points to the Q-order signal constellation;
wherein each point p_{q} is represented by a N-dimensional vector of coordinates: p_{q}=(α_{q1}, α_{q2}, . . . , α_{qN}), where q=1, 2, . . . , Q, where the Euclidean distance between points pₘ and pₙ is given by calculating the square root of the sum of the squared differences between the corresponding coordinates of the two vectors;
and a method for maximizing the minimum Euclidean distance between Q points, comprising formulating an optimization problem with the objective of maximizing the smallest Euclidean distance between any two points pₘ and pₙ. The optimization is subject to the following constraints: a first constraint that restricts the values of the variables to a range between −1 and 1 for all points, a second constraint that sets a lower boundary for the minimum required Euclidean distance between any two distinct points to ensure that the distance is non-zero, and a third constraint that ensures none of the optimized points coincide with the origin;
involving a heuristic method to solve the optimization problems, where Q_{N-D}∈R^{Q×N} is the optimized points which are mapped to Q-order signal constellation and are represented as
$${Q}_{N - D} = [ \begin{matrix}{β}_{11} & {β}_{21} & … & {β}_{Q 1} \\ {β}_{12} & {β}_{22} & & {β}_{Q 2} \\ ⋮ & & ⋱ & ⋮ \\ {β}_{1 N} & {β}_{2 N} & … & {β}_{QN}\end{matrix} ] .$$

10. The system as claimed in claim 8, wherein the N-D signal mapper 210 or 310 arrange the bits in N-parallel lines, and then each column is mapped to a symbol from the Q symbol, which is given as
$${X}_{N - D} = [ \begin{matrix}{β}_{11} & {β}_{21} & … & {β}_{p 1} \\ {β}_{12} & {β}_{22} & & {β}_{p 2} \\ ⋮ & & ⋱ & ⋮ \\ {β}_{1 N} & {β}_{2 N} & … & {β}_{pN}\end{matrix} ] .$$

11. The system as claimed in claim 5, wherein the I/Q converter 220 or 320 generates the I/Q samples as x_{I/Q} from the X_{N-D} that is transmitted in a digital communication system, the I component is generated from the even sequence of the vector form of X_{N-D}, while the Q component is generated from the odd sequence of the vector form of X_{N-D};
X_{N-D}=vec(X_{N-D}) whereby the I/Q samples are processed through layer mapping 230 or 330, wherein in the downlink communication, the data is then passed through the antenna mapping 240 and in the uplink communication system, the layer data passes through the transform precoding 340 and precoding 350, subsequently, the data symbols are mapped to the VRB 250 or 360 and mapped from VRB to PRB 260 or 370 for downlink and uplink, respectively and finally at the end of the modified PDSCH/PUSCH block 110, the information symbols x̅_{I/Q} treated as in the Delay-Doppler domain are obtained.

12. The system as claimed in claim 3, wherein the information symbols are arranged in an adaptive OTFS frame S∈C^{U×V}, whereby OTFS modulation 120 is applied on x̅_{I/Q} to transmit the time domain signal.

13. The system as claimed in claim 4, wherein the OTFS demodulator 150 at the receiver operates on received time-domain signal passes to get back the DD domain representation of transmitted information.

14. The system as claimed in claim 4, wherein the minimum mean squared error (MMSE) equalizers 160 at the receiver equalized the received signal with perfect channel state information to retrieve the I/Q samples \tilde{x}_{I/Q}.

15. The system as claimed in claim 5, wherein the N-D converter 440 or 540 performs the inverse operation of the I/Q converter 220 and produces \tilde{X}_{I/Q}, and the N-D signal de-mapper 450 or 550 demaps the symbol points in the N-D constellation using minimal distance judgment that maximizes the distance from the I/Q-mapped signal point \tilde{X}_{I/Q} to the possible constellation points, Q_{N-D}. The distance is calculated as the absolute value of the difference between the coordinates of the two points;
where the detected symbols are converted back to a stream of bits and the DL-SCH/UL-SCH decoder 180 subsequently decodes these information bits, reproducing the sent information bits.
